(19) United States
(12) Patent Application Publication
(10) Pub. No.: US 2006/0292385 A1
(43) Pub. Date: Dec. 28, 2006

(54) Method of plating mineral filled polyamide compositions and articles formed thereby

(76) Inventors: Andreas Renekn, Geneva (CH); Thierry Arpin, Annemasse (FR)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/188,571

(22) Filed: Jul. 25, 2005

Related U.S. Application Data
(60) Provisional application No. 60/591,533, filed on Jul. 27, 2004.

(51) Int. Cl. B05D 3/10; B32B 15/088

(52) U.S. Cl. 428/458; 427/304

(57) ABSTRACT

A method of preparing metal plated articles comprising mineral filled polyamide compositions containing plasticizer, and articles plated thereby. The plated articles have a decreased incidence of visible surface defects.

### CROSS REFERENCE TO RELATED APPLICATIONS

This application claims the benefit of U.S. Provisional Application No. 60/591,533, filed Jul. 27, 2004.

### FIELD OF THE INVENTION

The present invention relates to a method of preparing metal plated polyamide resin compositions containing mineral fillers. More particularly the present invention relates to a method of preparing such compositions containing fillers and plasticizers, along with a multitude of end-uses thereof.

### BACKGROUND OF THE INVENTION

Mineral filled polyamide resin compositions have good chemical resistance, stiffness, and dimensional stability. Such compositions are suitable for use in applications that require a good surface appearance and for such applications it is often desirable to metal plate articles made from the compositions. However, surface defects, such as marbling, which is often in the form of light-colored or white streaks or smears, frequently appear on the surface of articles molded from mineral filled polyamide compositions. These surface defects can be visible on the surface of the article even after plating. This results in a high rate of rejection of the plated articles.

EP patent 690 098 describes polyphthalamide blends comprising polyphthalamide, silicon oil, carboxyl-modified rubbery olefin polymer, and mineral filler. The blends are said to have improved plating adhesion and surface appearance when plated.

It would be desirable to have a method of obtaining plated articles with improved surface appearance comprising mineral filled polyamide compositions.

### SUMMARY OF THE INVENTION

There is disclosed and claimed herein a method of preparing a metal plated polyamide composition, comprising applying metal plating to an article comprising a polyamide composition comprising:

(a) about 40 to about 95 weight percent of at least one polyamide,

(b) about 5 to about 50 weight percent of at least one mineral filler, and

(c) about 0.1 to about 10 weight percent of at least one plasticizer, wherein the weight percentages are based on the total weight of the composition.

Moreover, there is disclosed and claimed herein a wide variety of articles plated by the method described herein and incorporating these compositions.

### DETAILED DESCRIPTION OF THE INVENTION

It has been discovered that metal plated mineral filled polyamide compositions with good surface appearance can be obtained when a polyamide composition obtained by melt-blending polyamide, mineral filler, and plasticizer is plated.

The polyamide used in the process of the present invention is at least one thermoplastic polyamide. Suitable polyamides can be condensation products of dicarboxylic acids and diamines, and/or aminocarboxylic acids, and/or ring-opening polymerization products of cyclic lactams. Suitable dicarboxylic acids include adipic acid, azelaic acid, sebacic acid, dodecanedioic acid, isophthalic acid, and terephthalic acid. Suitable diamines include tetramethylenediamine, hexamethylenediamine, octamethylenediamine, nonamethylenediamine, dodecamethylenediamine, 2-methylpentamethylenediamine, 2-methyloctamethylenediamine, trimethylhexamethylenediamine, bis(p-aminocyclohexyl)methane, m-xylylenediamine, and p-xylylenediamine. A suitable aminocarboxylic acid is 11-aminododecanoic acid. Suitable cyclic lactams are caprolactam and laurolactam. Preferred polyamides include aliphatic polyamide such as polyamide 6; polyamide 6,6; polyamide 4,6; polyamide 6,10; polyamide 6,12; polyamide 11; polyamide 12; and semi-aromatic polyamides such as poly(m-xylylene adipamide) (polyamide MXD,6), poly(dodecamethylene terephthalamide) (polyamide 12,T), poly(decamethylene terephthalamide) (polyamide 10,T), poly(nonamethylene terephthalamide) (polyamide 9,T), hexamethyleneadipamide-hexamethyleneterephthalamide copolyamide (polyamide 6,T/6,6), hexamethyleneterephthalamide-2-methylpentamethyleneterephthalamide copolyamide (polyamide 6,T/D,T); and copolymers and mixtures of these polymers. Preferred polyamides include polyamide 6; polyamide 6,6; polyamide 6,T/6,6; and polyamide 6,T/D,T.

The polyamide is present in about 40 to about 95 weight percent, and preferably in about 45 to about 90 weight percent of the composition, where the weight percentages are based on the total weight of the composition.

A variety of mineral fillers may be used in the process of the present invention. Without intending to limit the generality of the foregoing, examples include magnesium sulfate, calcined clay (aluminum silicate), wollastonite (calicum silicate), talc (magnesium silicate), barium sulfate, mica, titanium dioxide, sodium aluminum carbonate, barium ferrite, and potassium titanate.

When the process involves plating, it is preferred that the mineral filler be chosen such that it is insoluble in the etching solution used in plating under the conditions used for the etching.

The mineral filler is present in the polyamide composition in about 5 to about 50 weight percent, and preferably in about 15 to about 50 weight percent, based on the total weight of the composition.

The plasticizer used in the process of the present invention will be miscible with the polyamides used. Examples of plasticizers suitable for use in the present invention among others include sulfonamides, preferably aromatic sulfonamides such as benzenesulfonamides and toluenesulfonamides. Examples of suitable sulfonamides include N-alkyl benzenesulfonamides and toluenesufonamides, such as N-butylbenzenesulfonamide, N-(2-hydroxypropyl)benzenesulfonamide, N-ethyl-o-toluenesulfonamide, N-ethyl-p-toluenesulfonamide, o-toluenesulfonamide, p-toluenesulfonamide, and the like. Preferred are N-butylbenzenesulfonamide, N-ethyl-o-toluenesulfonamide, and N-ethyl-p-toluenesulfonamide. The plasticizer is present in the polyamide composition in about 0.1 to about 10 weight percent, and preferably in about 0.5 to about 5 weight percent, based on the total weight of the composition.

The polyamide composition may be prepared by melt-blending additional, optional ingredients such as reinforcing agents, impact modifiers, flame retardants, lubricants, heat stabilizers, light stabilizers, antioxidants, mold release agents, colorants, etc. A preferred reinforcing agent is glass fibers. A preferred additional ingredient is at least one organic carboxylic acid, such as one or more monocarboxylic acids, dicarboxylic acids, tricarboxylic acids, higher acids, or aminoacids. Preferred acids are dodecanedioic acid and adipic acid. When used, the organic acid will preferably be used at about 0.01 to about 3 weight percent, or more preferably at about 0.01 to about 1 weight percent, based on the total weight of the polyamide.

The compositions used in the present invention are in the form of a melt-mixed blend, wherein all of the non-polymeric ingredients are homogeneously dispersed in and bound by the polyamide matrix, such that the blend forms a unified whole. The blend may be obtained by combining the component materials using any melt-blending method as is understood among those having skill in this field. The component materials may be mixed to homogeneity using a melt-mixer such as a single or twin-screw extruder, blender, kneader, Banbury mixer, etc. to give a resin composition. Or, part of the materials may be blended in a melt-mixer, and the rest of the materials may then be added and further melt-blended until homogeneous.

Articles comprising the polyamide compositions used in the present invention may be prepared by molding according to methods known to those skilled in the art. Preferred are commonly used melt-molding methods such as injection molding, extrusion molding, blow molding, injection blow molding, gas injection molding, water injection molding, and the like.

The articles may be metal plated using processes known to those skilled in the art. Typically such processes involve etching the surface of the article with an acid such as a chromic acid/sulfuric acid blend, followed by depositing a plating catalyst such as tin-stabilized colloidal palladium particles on the surface, subsequent removal of the tin stabilizer, applying an electroless deposition of a layer of metal such as nickel or copper, and applying an electrolytic deposition (galvanoplating) of metals such as copper, nickel, and/or chromium. A detailed description of a suitable process can be found in U.S. Pat. No. 3,445,350, incorporated by reference herein.

The article metal plated in the process of the present invention may be used in automotive applications such as interior or exterior door handles, trunk handles, gear shifters, logos, steering wheels, wheel covers, hub caps, trim, and engine covers, tank filler caps and handle bar ends for motorcycles and scooters, and the like. The article may be used in hardware applications such as appliance (e.g. refrigerator, oven, etc.) handles, drawer pulls and knobs, cupboard handles and knobs, shower heads, faucets and faucet handles, mirror frames, towel racks, soap dishes, toilet paper holders, toilet flush handles, switch and outlet cover plates, supports, brackets, etc. The article may be used in household applications such as glass racks, champagne buckets, perfume bottle stoppers, wine racks, knife racks, and in electronics applications such as camera, video camera, cell phone, and computer housings. It is readily appreciated that given the range of uses and applications listed as above, other articles beyond these and covering myriad applications are envisioned.

The plated mineral filled polyamide articles prepared using the process of the present invention have fewer surface defects and improved surface appearance over those made using compositions not containing plasticizer.

### EXAMPLES

The materials used in the tables describing the examples and comparative examples are identified as follows:

Polyamide 6 is a polyamide with a relative viscosity of 47.

Calcined clay is Polarite® 102A, available from Imerys Minerals Ltd., Cornwall UK.

The heat stabilizer is a blend of potassium iodide, copper iodide, and aluminum distearate.

Notched Charpy impact strength was measured dry-as-molded using ISO 179/1eA. Tensile modulus, stress at break, and strain at break were measured dry-as-molded using ISO 157-½.

Surface appearance was assessed by injection molding plaques using a standard injection molding machine at varying injection speeds. The surface of each plaque was visually inspected for defects. If the surface showed appearance defects, which were predominately marbling, or white streaks and smears, it was deemed to be unacceptable. The highest injection rate at which the composition could be injection molded without exhibiting marbling is given in Table 1 under the heading of “maximum injection rate without marbling.” A rate of at least 20 mm/s is deemed acceptable.

Samples were chrome-plated using standard plating techniques in a commercial plating facility.

### Examples 1-6 and Comparative Example 1

The ingredients shown in Table 1 for Examples 1-6 were melt-blended in an 55 mm kneader operating at about 260° C. The melt temperature was about 300° C. The plasticizer was fed through a liquid injector close to the die. Upon exiting the extruder the stand was cooled and cut into pellets. Comparative Example 1 was Minlon® 73M40 NC010, available from E.I. du Pont de Nemours & Company, Inc. of Wilmington, Del. The physical properties and injection molding rates that yielded molded plaques that exhibited no marbling of the compositions were determined and the results are shown in Table 1.

TABLE 1

| | | | | | | | Comp. |
|---|---|---|---|---|---|---|---|
| | Ex. 1 | Ex. 2 | Ex. 3 | Ex. 4 | Ex. 5 | Ex. 6 | Ex. 1 |
| Polyamide 6 | 63.88 | 59.88 | 54.82 | 57.3 | 58.8 | 56.68 | 60 |
| Calcined clay | 35 | 35 | 40 | 40 | 40 | 38 | 40 |
| N- | 1 | 5 | 5 | 2.5 | 1 | 5 | — |
| Butyl- | | | | | | | |
| benzenesulfonamide | | | | | | | |
| Dodecanedioic | 0.12 | 0.12 | 0.18 | 0.2 | 0.2 | 0.12 | — |
| acid | | | | | | | |
| Heat stabilizer | — | — | — | — | — | 0.2 | — |
| Tensile modulus | 5.73 | 4.05 | 4.35 | 5.84 | 5.99 | 3.98 | 5.96 |
| (GPa) | | | | | | | |
| Stress at Break | 85.4 | 69.2 | 68.2 | 79.7 | 84.7 | 67.6 | 84.5 |
| (MPa) | | | | | | | |
| Strain at Break (%) | 6.3 | 18.3 | 13.3 | 6.8 | 9.3 | 17.6 | 14.4 |
| Notched Charpy | 3.6 | 4.4 | 3.7 | 3.6 | 3.6 | 5.6 | 6.7 |
| impact | | | | | | | |
| strength (kJ/m²) | | | | | | | |
| Maximum injection | 20 | 60 | 80 | 60 | 40 | 40 | <20 |
| rate without | | | | | | | |
| marbling (mm/s) | | | | | | | |

All ingredient quantities are given in weight percent relative to the total weight of the composition.

When plaques injection molded from the composition of Comparative Example 1 were chrome plated, the defects visible on the surface were clearly visible on the plated surface. When plaques were injection molded from the composition of Example 6, no surface defects were visible. When these plaques were chrome plated there were no defects visible on the surface. When articles molded from the compositions of Examples 4 and 5 were chrome plated, there were no readily apparent surface appearance defects on the plated surface.

What is claimed is:

1. A method of preparing a metal plated polyamide composition, comprising applying metal plating to an article comprising a polyamide composition comprising:
(a) about 40 to about 95 weight percent of at least one polyamide,
(b) about 5 to about 50 weight percent of at least one mineral filler, and
(c) about 0.1 to about 10 weight percent of at least one plasticizer,
wherein the weight percentages are based on the total weight of the composition.

2. The method of claim 1 wherein the polyamide is one or more of polyamide 6; polyamide 6,6; polyamide 6,T/6,6; or polyamide 6,T/D,T.

3. The method of claim 1 wherein the polyamide composition is prepared by additionally melt-blending (d) about 0.01 to about 3 weight percent of at least one organic acid based on the total weight of the polyamide (a).

4. The method of claim 3 wherein the organic acid is dodecanedioic acid and/or adipic acid.

5. The method of claim 1 wherein the mineral filler is calcined clay, talc, and/or wollastonite.

6. The method of claim 1 wherein the plasticizer is one or more of N-butylbenzenesulfonamide, N-ethyl-o-toluenesulfonamide, or N-ethyl-p-toluenesulfonamide.

7. The method of claim 1 wherein the metal plating step comprises etching the surface of the article with acid; applying a plating catalyst to the etched surface; applying an electroless metal plating; and applying a galvanoplating.

8. An article plated by the method of claim 1.

9. The article of claim 8 in the form of a vehicle door handle, trunk handle, gear shifter, logo, steering wheel, wheel cover, trim element, or hub cap.

10. The article of claim 8 in the form of a motorcycle or scooter engine cover, tank filler cap, trim element, or handle bar end.
